(19) United States
(12) Patent Application Publication
(10) Pub. No.: US 2025/0348879 A1
(43) Pub. Date: Nov. 13, 2025

(54) SYSTEMS AND METHODS FOR MITIGATING TRAVEL-RELATED TRANSACTION FRAUD RISK USING MACHINE LEARNING MODEL.

(71) Applicant: Expedia, Inc., Seattle, WA (US)

(72) Inventors: Peter Hoekstra, Seattle, WA (US); Samrat Halder, Bothell, WA (US); David Brooks, Bainbridge Island, WA (US); Ijya Paudel, Seattle, WA (US); Ashley Watts, Springfield, MO (US); Robert Brummel, Springfield, MO (US)

(73) Assignee: Expedia, Inc., Seattle, WA (US)

(21) Appl. No.: 18/658,526

(22) Filed: May 8, 2024

(51) Int. Cl. G06Q 20/40

(52) U.S. Cl. CPC G06Q 20/4016

(57) ABSTRACT

A computing system for automated fraud risk reduction for travel-related transactions, the computing system including at least one processing circuit including at least one processor and at least one memory, the at least one memory storing instructions therein that, when executed by the at least one processor, cause the at least one processor to: receive data corresponding to a first travel-related transaction, process, using a first machine learning model, the data to automatically generate an output data set comprising a plurality of characteristics relating to the first travel-related transaction, the first machine learning model configured to generate the output data set by identifying the plurality of characteristics to include responsive to determining the plurality of characteristics are potentially relevant to a determination of whether the first travel-related transaction is fraudulent, and provide the generated output data set for use in analyzing whether the first travel-related transaction is fraudulent.

### TECHNICAL FIELD

Embodiments of the present disclosure relate generally to systems and methods for reviewing potentially fraudulent transactions using artificial intelligence.

### BACKGROUND

Fraud detection in a travel domain may differ from other types of eCommerce use-cases, such as credit card fraud. While fraud in travel may occur through a stolen credit card, fraud in the travel domain may have a lack of merchant and customer payment or card usage history. Fraud analysts may rely on the travel product, for example, a flight reservation, and base a determination of a fraudulent transaction around the travel product.

### SUMMARY

At least one aspect relates to a system. A computing system for automated fraud risk reduction for travel-related transactions includes at least one processing circuit including at least one processor and at least one memory, the at least one memory storing instructions therein that, when executed by the at least one processor, cause the at least one processor to receive data corresponding to a first travel-related transaction, process, using a first machine learning model, the data to automatically generate an output data set including a plurality of characteristics relating to the first travel-related transaction, the first machine learning model configured to generate the output data set by identifying the plurality of characteristics to include responsive to determining the plurality of characteristics are potentially relevant to a determination of whether the first travel-related transaction is fraudulent, and provide the generated output data set for use in analyzing whether the first travel-related transaction is fraudulent.

In various embodiments, the instructions further cause the at least one processor to train the first machine learning model using a training data set relating to a plurality of historical travel-related transactions, the training data set including classifications of the historical travel-related transactions as fraudulent or not fraudulent and analysis notes for the historical transactions relating to why the historical first travel-related transaction transactions were classified as fraudulent or not fraudulent. The analysis notes may include a plurality of characteristics relating to properties or services being offered as part of the historical travel-related transactions, entities offering the properties or services as part of the historical travel-related transactions, entities accepting the offers of the properties or services as part of the historical travel-related transactions, and/or financial information relating to the historical travel-related transactions. In various embodiments, the instructions, when executed by the at least one processor, further cause the at least one processor to classify, by at least one of the first machine learning model or a second machine learning model, a likelihood of the first travel-related transaction being fraudulent. In various embodiments, the instructions, when executed by the at least one processor, further cause the at least one processor to automatically initiate an action for processing the first travel-related transaction based on the classified likelihood of the first travel-related transaction being fraudulent.

In various embodiments, the at least one processor is configured to classify the likelihood of the first travel-related transaction being fraudulent using a first threshold. In various embodiments, the instructions, when executed by the at least one processor, further cause the at least one processor to automatically approve the first travel-related transaction without human review responsive to the likelihood of the first travel-related transaction being fraudulent being classified as below the first threshold. In various embodiments, the at least one processor is configured to classify the likelihood of the first travel-related transaction being fraudulent using a first threshold. In various embodiments, the instructions, when executed by the at least one processor, further cause the at least one processor to provide the generated output data set to an analyst for human review responsive to the likelihood of the first travel-related transaction being fraudulent being classified as above the first threshold.

In various embodiments, the at least one processor is further configured to classify the likelihood of the first travel-related transaction being fraudulent using a second threshold higher than the first threshold. In various embodiments, the instructions, when executed by the at least one processor, further cause the at least one processor to block the first travel-related transaction or move the first travel-related transaction into a queue for later processing responsive to the likelihood of the first travel-related transaction being fraudulent being classified as above the second threshold. In various embodiments, the generated output data set is provided to an analyst.

In various embodiments, the instructions, when executed by the at least one processor, further cause the at least one processor to generate, using a second machine learning model configured to provide an automated chatbot for use by the analyst, additional information relating to the first travel-related transaction using input from the analyst provided via the chatbot, generate, by the first machine learning model using the additional information, an updated output data set including a second plurality of characteristics potentially relevant to a determination of whether the first travel-related transaction is fraudulent.

In various embodiments, the instructions, when executed by the at least one processor, further cause the at least one processor to automatically provide the updated output data set to the analyst via automated chatbot using the second machine learning model. In various embodiments, the generated output data set includes a narrative including the plurality of characteristics potentially relevant to whether the first travel-related transaction is fraudulent. In various embodiments, the narrative includes a natural language narrative including one or more natural language phrases and/or sentences. In various embodiments, the instructions, when executed by the at least one processor, further cause the at least one processor to train the first machine learning model using a training data set relating to a plurality of historical travel-related transactions, the training data set including classifications of the historical travel-related transactions as fraudulent or not fraudulent and analysis notes from human analysts for the historical travel-related transactions including natural language explanations relating to why the historical travel-related transactions were classified as fraudulent or not fraudulent. In various embodiments, the at least one processor is configured to determine a form and content of the narrative for the first travel-related transaction based at least in part on a form and content of the analysis notes from the training data set.

In various embodiments, the first travel-related transaction is an accommodation reservation. The plurality of characteristics may include at least one of a location of the reservation or a location of a device used to make the reservation. In various embodiments, the first travel-related transaction is a listing of a property. The plurality of characteristics may include at least one of a location of the property, a location of a host of the property, or a bank location of the host. In various embodiments, the first machine learning model is a generative artificial intelligence model.

At least one aspect relates to a method for reducing automated fraud risk for travel-related transactions. The method may include receiving, by one or more processors, data corresponding to a first travel-related transaction, processing, by the one or more processors, using a first machine learning model, the data to automatically generate an output data set including a plurality of characteristics relating to the first travel-related transaction, the first machine learning model configured to generate the output data set by identifying the plurality of characteristics to include responsive to determining the plurality of characteristics are potentially relevant to a determination of whether the first travel-related transaction is fraudulent, and providing the generated output data set for use in analyzing whether the first travel-related transaction is fraudulent.

In various embodiments, the method further includes training, by the one or more processors, the first machine learning model using a training data set relating to a plurality of historical travel-related transactions. The training data set may include classifications of the historical travel-related transactions as fraudulent or not fraudulent and analysis notes for the historical transactions relating to why the historical first travel-related transaction transactions were classified as fraudulent or not fraudulent. The analysis notes may include a plurality of characteristics relating to properties or services being offered as part of the historical travel-related transactions, entities offering the properties or services as part of the historical travel-related transactions, entities accepting the offers of the properties or services as part of the historical travel-related transactions, and/or financial information relating to the historical travel-related transactions. In various embodiments, the generated output data set includes a narrative including the plurality of characteristics potentially relevant to whether the first travel-related transaction is fraudulent.

At least one aspect relates to one or more non-transitory computer readable mediums including instructions executable by one or more processors. The instructions cause the processors to receive data corresponding to a first travel-related transaction, process, using a first machine learning model, the data to automatically generate an output data set including a plurality of characteristics relating to the first travel-related transaction, the first machine learning model configured to generate the output data set by identifying the plurality of characteristics to include responsive to determining the plurality of characteristics are potentially relevant to a determination of whether the first travel-related transaction is fraudulent, and provide the generated output data set for use in analyzing whether the first travel-related transaction is fraudulent.

In various embodiments, the instructions further cause the one or more processors to train the first machine learning model using a training data set relating to a plurality of historical travel-related transactions, the training data set including classifications of the historical travel-related transactions as fraudulent or not fraudulent and analysis notes for the historical transactions relating to why the historical first travel-related transaction transactions were classified as fraudulent or not fraudulent. The analysis notes may include a plurality of characteristics relating to properties or services being offered as part of the historical travel-related transactions, entities offering the properties or services as part of the historical travel-related transactions, entities accepting the offers of the properties or services as part of the historical travel-related transactions, and/or financial information relating to the historical travel-related transactions.

### BRIEF DESCRIPTION OF THE DRAWINGS

FIG. 1 depicts a block diagram of a system for reviewing potentially fraudulent transactions, according to an example embodiment.

FIG. 2 depicts a block diagram of an artificial intelligence (AI) sub-system of FIG. 1, according to an example embodiment.

FIG. 3 depicts a block diagram of an AI model of the AI sub-system of FIG. 1, according to an example embodiment.

FIG. 4 depicts a flow diagram of a method of automated fraud risk reduction for travel-related transactions, according to an example embodiment.

FIG. 5 depicts a method of classifying a likelihood of fraudulence of a transaction, according to an example embodiment.

FIG. 6 depicts a method of reviewing a potentially fraudulent transaction using a machine learning model, according to an example embodiment.

FIG. 7 depicts a method of reviewing a potentially fraudulent transaction using a first machine learning model and a second machine learning model, according to an example embodiment.

FIG. 8A depicts a first narrative generated by a fraud analyst, according to an example embodiment.

FIG. 8B depicts a second narrative generated by a fraud analyst, according to an example embodiment.

FIG. 9A depicts a first narrative generated by a machine learning model, according to an example embodiment.

FIG. 9B depicts a second narrative generated by a machine learning model, according to an example embodiment.

### DETAILED DESCRIPTION

Below are detailed descriptions of various concepts related to and implementations of techniques, approaches, methods, apparatuses, and systems for training and/or utilizing machine learning models to help with assessing fraud risk for travel-related transactions. The various concepts introduced above and discussed in detail below may be implemented in any of numerous ways, as the described concepts are not limited to any particular manner of implementation. Examples of specific implementations and applications are provided primarily for illustrative purposes.

Referring generally to the Figures, aspects and embodiments of the present disclosure relate to systems, computer-readable media, and methods that improve fraud detection for travel-related transactions. According to some example embodiments, fraud detection, specifically in the travel domain, is improved by training an instruction-tuned large language model (LLM) or other machine learning model to review potentially fraudulent transactions and generate information about the potentially fraudulent transactions. For example, the LLM may generate a data set including characteristics about the transaction that may be relevant to a determination of whether the transaction is fraudulent. The LLM may provide the data set to a human analyst to review and make a final determination about whether the transaction is fraudulent. In various embodiments, the LLM may utilize the generated data set to generate a preliminary determination about the likelihood of the transaction being fraudulent. The preliminary determination may be confirmed by the analyst, or the analyst may reverse the determination (e.g., if the LLM determines the transaction is fraudulent, the analyst may determine the transaction is not fraudulent). In some embodiments, the LLM may automatically assess the transaction and determine whether the transaction is or is not fraudulent, or should or should not be approved, without human intervention/approval.

Fraud can manifest in various ways across different platforms. Fraud in online travel agencies (OTAs) may differ from fraud in other non-travel related e-commerce platforms. For example, OTA fraud may take the form of deceptive bookings or reservations. Cybercriminals may exploit vulnerabilities in the booking process and may utilize stolen credit card information to make reservations for flights, hotels, or other travel services. Cybercriminals may also create deceptive listings and/or deploy phishing tactics aimed to compromise an existing supplier to exploit various payout avenues. These fraudulent activities can result in financial losses for the OTA, its partners, and travelers or users of the OTA. Moreover, the intangible nature of travel services may make it challenging to verify the legitimacy of a booking or property. Meanwhile, fraud across other e-commerce platforms, such as retail websites, may involve the purchase of physical goods. Unlike travel services, physical products can be inspected upon delivery, allowing consumers and merchants to identify fraudulent transactions. To prevent fraud across multiple channels such as traveler bookings, lodging supply listings, and user logins, machine learning models, which may be based on boosting trees, in some implementations, may be used to determine fraudulent transactions.

In some embodiments, systems and methods disclosed herein may aid manual review for fraud detection in travel domain. Conventionally, human agents may review transactions that have been flagged as potentially fraudulent. Each agent may manually review each transaction to assess a likelihood that the transaction is fraudulent. This process may be costly, both in time of the analyst and in resources spent for a single fraud determination. Manual review may differ from auto-detection in that humans can spot new patterns and use judgement to assess a transaction in ways that a machine cannot. However, it may take many years of experience to fine tune the ability to determine fraud, and less experienced analysts may not be accurate as those with greater experience.

According to some embodiments, systems and methods described herein may aid in generating and sharing the knowledge with all analysts to make decisions faster and more accurately. Beneficially, training an artificial intelligence (AI) or machine learning (ML) model to generate a likelihood that a transaction is fraudulent and/or information relevant to the determination of whether a transaction is fraudulent may enable faster reviews of transactions by agents, which may decrease a cost-per-transaction (e.g., financial cost, human and machine or computing resource cost, etc.) for fraud review and may enable scaling of the fraud review process. The AI system may be trained on transactions that have been previously reviewed by agents and classified as fraudulent or not to generate a narrative output or other type of output indicating factors that have been considered when determining whether a reviewed transaction is potentially fraudulent or not. With the help of analysts, a curated instruction dataset may be generated, with an emphasis on principles of fraud review in travel domain across multiple channels (e.g., booking (air, hotel, vacation rental, car), listing (vacation rental, conventional lodging), login (account takeover)). An instruction-tuned LLM trained on this dataset can leverage human domain knowledge with embedded world knowledge of a base open-source LLM to provide guidance on fraud signals present in each transaction queued for human review, in some implementations.

In some embodiments, the instruction tuned LLM may combine a parametric knowledge base with human annotated instruction datasets relating to fraud to help analysts make faster decisions on transactions queued for review in the fraud detection process. The machine learning model may also provide a recommended suggestion about the likelihood of a transaction being fraudulent, in some implementations. The model may generate the notes or other data an investigator might generate or review for a given transaction to assess the risk of the transaction being fraudulent. For example, a sample output might highlight the distance between the location of the traveler and the departing airport as being suspiciously far, which the investigator could integrate into their assessment. A travel domain specific, instruction tuned LLM may augment an analyst review process where when a transaction is queued for operational review. The LLM may accumulate transaction related data and, in response, return a suggested fraud decision (e.g., fraud/non-fraud/abstain) based on in-house and open-source data available through, for example, APIs, with a narrative on the decision-making process.

Utilizing the systems, methods, and features described herein, according to various example implementations, may provide a variety of technical benefits, including, but not limited to: (1) reducing an amount of manual time and effort to assess travel-related transactions and computing and other resource consumption associated with such manual reviews; (2) increasing a speed of the review of travel-related transactions, such that non-fraudulent transactions can be processed more quickly and fraudulent transactions can be assessed and blocked more quickly, which can be important for travel-related offers where offers and resources can change quickly; (3) increasing an accuracy of the review of travel-related transactions, such that a greater amount of true-positive, non-fraudulent transactions are approved and a greater amount of true-negative, fraudulent transactions are blocked, while reducing an amount of false-positive and false-negative assessments; (4) automatically providing a greater amount of relevant, actionable information to analysts, such that the analysts can quickly and completely assess transactions without taking the time to manually cull through a large data set to identify relevant indicators and/or make quick decisions on incomplete information; (5) allowing less experienced/knowledgeable analysts to operate at a higher level of accuracy (e.g., similar to more experienced analysts) by processing the underlying data and providing the analysts with the information deemed most pertinent to assessing the fraud risk, without requiring the analysts to necessarily have the knowledge or experience to know how to review, filter, and cross-reference the underlying data themselves; and (6) processing the underlying data to identify the indicators/characteristics within the data relevant to assessing the fraud risk, such that the time and computing resources to manually cull through the larger dataset and identify the relevant indicators for a wide variety of different scenarios, circumstances, types of transactions, etc. is reduced while providing more complete and accurate information for consideration in assessing the fraud risk.

Before turning to the Figures, which illustrate certain example embodiments in detail, it should be understood that the present disclosure is not limited to the details or methodology set forth in the description or illustrated in the Figures. It should also be understood that the terminology used herein is for the purpose of description only and should not be regarded as limiting.

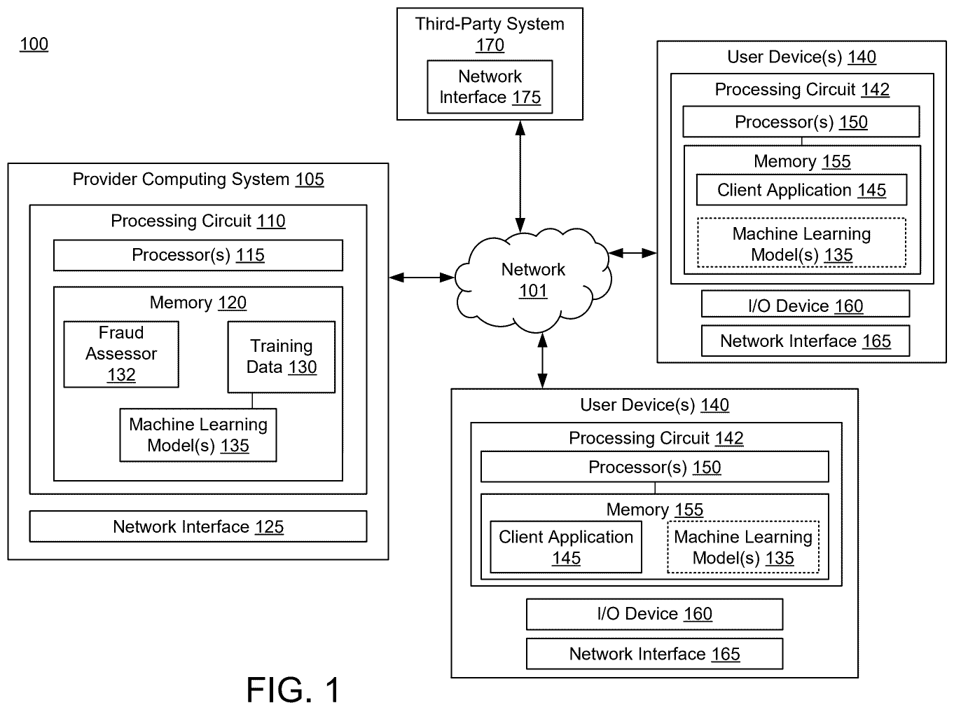

FIG. 1 illustrates an example system 100 for training and/or providing a machine learning model to help assess a fraud risk of travel-related transactions, according to an example embodiment. In some implementations, various components and/or systems of the system 100 may be configured to generate and provide a determination on whether transactions associated with traveling and/or trip planning (e.g., hotels, resorts, rental properties, etc.) are fraudulent or likely fraudulent. More specifically, the recommendations may relate to one or more processes involved in booking travel, such as booking flights, hotels, lodging, etc.

According to some embodiments, the system 100 includes a provider computing system 105 coupled to one or more user devices 140 and one or more third-party systems 170 via a network 101. The provider computing system 105 may be a computing system associated with a provider entity. The provider organization or entity may be a provider of goods and/or services. In this example, the provider entity is a travel services/experiences provider, such as a travel agency or travel broker (e.g., a company that allows users to book travel services provided by other companies), which provides and maintains one or more accounts on behalf of the user. The provider may be a transportation provider (e.g., airline, car or rental vehicle service, rideshare/taxi service etc.), a lodging provider (e.g., hotel, rental property, cruise, etc.), an experience provider (e.g., theme parks, concerts, shows, events, excursions, etc.), or any combination thereof. In the example shown, the provider is a travel or experience booking agency that provides or enables a variety of experiences by interfacing/communicating with other providers (e.g., lodging providers, airline providers, etc.). Specifically, the provider computing system 105 may be utilized by an agent or analyst of the provider organization that reviews transactions associated with user accounts associated with the provider organization. Provider computing system 105 may receive a plurality of transactions that may be reviewed for potential fraudulence.

Fraudulent transactions may be or include transactions performed by a fraudster or cybercriminal. For example, a fraudster may utilize stolen credit card or other payment information to make reservations for flights, hotels, and/or other travel services. Further, fraudsters may generate false or fraudulent listings (e.g., vacation rental listings) or deploy phishing tactics that compromise suppliers of the provider organization. Additionally, fraudsters may access user accounts of users associated with the provider organization and make fraudulent reservations through the user account. A user that believes fraudulent purchases, reservations, bookings, etc. have been made through the provider organization using their credit card and/or user account may be able to report the transaction as potentially fraudulent. A case may be opened for the potentially fraudulent transaction and may undergo a review process.

The provider computing system 105 can include at least one processing circuit 110, which may, as an example, include at least one processor 115 and at least one memory 120. The provider computing system 105 may include one or more servers that include one or more of the processors and/or memory components described above and herein. The memory 120 can store computer-executable instructions that, when executed by the processor 115, cause the processor 115 to perform one or more of the operations described herein. The processor 115 may include a microprocessor, an application-specific integrated circuit (ASIC), a field-programmable gate array (FPGA), a graphics processing unit (GPU), a tensor processing unit (TPU), etc., and/or combinations thereof. The memory 120 may include, but is not limited to, electronic, optical, magnetic, or any other storage or transmission device capable of providing the processor 115 with program instructions. The memory 120 may further include a magnetic disk, memory chip, read-only memory (ROM), random-access memory (RAM), electrically erasable programmable ROM (EEPROM), erasable programmable ROM (EPROM), flash memory, optical media, or any other suitable memory from which the processor can read instructions. The instructions may include code from any suitable computer programming language. The provider computing system 105 can include one or more computing devices or servers that can perform various of the operations or functions described herein. The memory 120 may store training data 130, a fraud assessor 132, and a machine learning model 135, each of which will be described in greater detail herein.

The provider computing system 105 can be structured as one or more backend computing systems including one or more servers and other computing components, in some embodiments. The provider computing system 105 (e.g., the memory 120) may include a fraud assessor 132 that may classify a likelihood of whether a transaction is fraudulent. For example, the provider computing system 105 may receive an indication that a user has reported a transaction as potentially fraudulent. The fraud assessor 132 may be implemented as part of the machine learning model 135 that will be described in greater detail below or may be implemented as a separate machine learning model or other algorithm (e.g., such that the machine learning model 135 generates an output data set or narrative with information relevant to whether the transaction may or may not be fraudulent and a separate algorithm or machine learning model classifies the transaction as fraudulent or not fraudulent or otherwise provide an indication of the fraud risk level associated with the transaction). The fraud assessor 132 may receive details relating to the potentially fraudulent transaction. The details may include, for example, the user account and personal information associated with the transaction (e.g., phone number, email, saved credit card, etc.), an IP address of the computer that has performed the transaction, etc. In instances where the potential fraud involves a potentially fraudulent listing, the details may include a listing location and a location of the device posting the listing. Additional details may include supplier information, such as a supplier banking institution, and additional location details, such as a location of the user performing the transaction, a location of a user listing a property, a location of the listed property, etc.

Based on the received transaction information, the fraud assessor 132 may categorize or quantify a fraud risk of the transaction, such as by categorizing the transaction as having a high, moderate, or low risk or likelihood of being fraudulent. The fraud assessor 132 may review the transaction details and determine an estimated risk of fraud based on the transaction details. Based on the number and/or type of details deemed indicative of fraud, the fraud assessor 132 may classify the transaction. For example, if the estimated fraud risk is less than a first predetermined threshold value (e.g., low number of indicators indicative of likely fraud, indicators are not highly suggestive of fraud, etc.), the fraud assessor 132 may classify the transaction as having a low likelihood of being fraudulent. Responsive to a determination that the potential fraud indicators are below the first predetermined threshold value, the fraud assessor 132 may determine that the transaction is not fraudulent and may automatically approve or allow the transaction, in some implementations.

In various embodiments, a second predetermined threshold value may be greater than the first predetermined threshold value. An estimated fraud risk may be greater than the first predetermined threshold value and less than a second predetermined threshold value. If estimated fraud risk is greater than or equal to the first predetermined threshold value but less than a second predetermined threshold value (e.g., a moderate number of indicators indicative of likely fraud, indicators are moderately suggestive of fraud, etc.), the fraud assessor 132 may classify the transaction as having a moderate likelihood of being fraudulent. Responsive to a determination that the transaction has a moderate likelihood of being fraudulent, the fraud assessor 132 may forward the transaction to an analyst for review (e.g., along with contextual information or other output data relevant to the fraud risk assessment of the transaction generated by the machine learning model 135). If the estimated fraud risk is greater than or equal to the second predetermined threshold value (e.g., a high number of indicators indicative of likely fraud, indicators are highly suggestive of fraud, etc.), the fraud assessor 132 may classify the transaction as having a high likelihood of being fraudulent. Responsive to a determination that the transaction has a high likelihood of being fraudulent, the fraud assessor 132 may automatically block the transaction from occurring, in some implementations. In other implementations, the fraud assessor 132 may place the transaction in a queue for later assessment (e.g., human assessment after the moderate risk transactions).

In various embodiments, the fraud assessor 132 may additionally or alternatively classify the transactions based on a severity or type of one or more potential fraud indicators. For example, a transaction that is classified as having a high likelihood of being fraudulent may have a number of potential fraud indicators less than the second predetermined threshold value, but the potential fraud indicators may be determined to be highly indicative of potential fraud. In various embodiments, the fraud assessor 132 may classify the transactions based on both a severity of the potential fraud indicators and a number of identified potential fraud indicators.

Responsive to a transaction being classified as highly likely to be fraudulent, the fraud assessor 132 may automatically block the transaction or otherwise prevent the transaction from occurring. Blocking the transaction may include, for example, cancelling a reservation, blocking a reservation or payment, preventing a payment from being processed, unconfirming or not confirming a reservation or booking, removing a listing, etc. Responsive to a transaction being classified as a moderate or low likelihood to be fraudulent, the transaction may be further reviewed by the machine learning model 135. The machine learning model 135 will be described later in this application. Responsive to review by the machine learning model 135, the transaction may be sent to a queue to be reviewed by an agent or fraud analyst utilizing the provider computing system 105. In various embodiments, the machine learning model 135 may review only a portion of all transactions performed using the provider organization (e.g., only transactions flagged as potentially fraudulent). Additionally, in various embodiments, the machine learning model 135 may only review a portion of transactions flagged as potentially fraudulent (e.g., only transactions determined to have a moderate likelihood of being fraudulent). Operating the machine learning system 135 in this manner may reduce energy consumption, computing resource utilization, etc. for one or more components of the system 100 (e.g., the provider computing system 105) compared to if the machine learning system 135 reviews all transactions.

In various embodiments, the machine learning model 135 may review all transactions. Additionally, in various embodiments, the machine learning model 135 may process raw, underlying data corresponding to each of the transactions performed using the provider organization. The machine learning model 135 may extract, from the raw data, any data that may be relevant to assessing the likelihood that the transaction is fraudulent. The machine learning model 135 and/or the fraud assessor 132 may utilize the extracted data to generate the likelihood of fraudulence. For example, the machine learning model 135 may extract relevant data corresponding to the transaction and may transmit the data to the fraud assessor 132. The fraud assessor 132 may determine a likelihood of fraud, and the fraud assessor 132 may forward the transaction to a human analyst for further review. In various embodiments, the fraud assessor 132 and the machine learning model 132 may operate independently of one another.

The provider computing system 105 can store or otherwise have access to training data 130. Training data 130 may include data collected from a point of sale when a transaction occurs on the provider computing system 105, in some implementations. This data may be retrieved by, for example, an application programming interface (API), such as from one or more third-party computing systems. The training data 130 may include a plurality of previously reported and reviewed potentially fraudulent transactions (e.g., a plurality of historical travel-related transactions). The training data may include classifications of the historical travel-related transactions as fraudulent or not fraudulent and analysis notes for the historical transactions relating to why the historical first travel-related transaction transactions were classified as fraudulent or not fraudulent. Specifically, the analyst notes may include characteristics relating to properties or services being offered as part of the historical travel-related transactions, entities offering the properties or services as part of the historical travel-related transactions, entities accepting the offers of the properties or services as part of the historical travel-related transactions, and/or financial information relating to the historical travel-related transactions. For example, the training data 130 may include transactions that have previously been classified as having a low to moderate likelihood of being fraudulent, have been reviewed by an agent or fraud analyst, and have been definitively determined to be fraudulent or not. The training data 130 may include verbatim narratives generated by agents corresponding to each transaction. The narrative may include one or more reasons or explanations as to why the agent has deemed the transaction fraudulent or not. For example, the provider computing system 105 includes one or more machine learning models 135 that can be trained using the training data 130, as described in greater detail herein. Although shown as internal to the provider computing system 105, it should be understood that the training data 130 may be stored external to the provider computing system 105, for example, as part of a cloud computing system or an external storage medium in communication with the provider computing system 105 via the network 101. In some embodiments, although shown internal to the provider computing system 105, the machine learning models 135 may be implemented via the user device(s) 140.

Each component (e.g., the provider computing system 105, the network 101, the machine learning model 135, the user devices 140, the third-party systems 170, etc.) of the system 100 can be implemented using the hardware components or a combination of software with the hardware components of any computing system described herein. Each component of the system 100 can perform one or more of the functionalities detailed herein.

The provider computing system 105 can include a network interface 125. In some instances, the network interface 125 includes, for example, program logic and any associated hardware components (e.g., transceivers, ethernet cards, etc.) that connects the provider computing system 105 to the network 101. The network interface 125 facilitates secure communications between the provider computing system 105 and each of the user device(s) 140 and third party system(s) 170. The network interface 125 also facilitates communication with other entities, such as other providers of goods and/or services. The network interface 125 further includes user interface program logic configured to generate and present web pages to users accessing the provider computing system 105 over the network 101.

The network 101 can include packet-switching computer networks such as the Internet, local, wide, metro, or other area networks, intranets, satellite networks, other computer networks such as voice or data mobile phone communication networks, or combinations thereof. The provider computing system 105 of the system 100 can communicate via the network 101 with one or more computing devices, such as the one or more user devices 140 and the one or more third-party systems 170. The network 101 may be any form of computer network that can relay information between the provider computing system 105, the one or more user devices 140, the one or more third-party systems 170, and one or more information sources, such as web servers or external databases, amongst others. In some implementations, the network 101 may include the Internet and/or other types of data networks, such as a local area network (LAN), a wide area network (WAN), a cellular network, a satellite network, or other types of data networks. The network 101 may also include any number of computing devices (e.g., computers, servers, routers, network switches, etc.) that are configured to receive or transmit data within the network 101.

The network 101 may include any number of hardwired or wireless connections. Any or all of the computing devices described herein (e.g., the provider computing system 105, the one or more user devices 140, the one or more third-party systems 170, etc.) may communicate wirelessly (e.g., via Wi-Fi, cellular communication, radio, etc.) with a transceiver that is hardwired (e.g., via a fiber optic cable, a CAT5 cable, etc.) to other computing devices in the network 101. Any or all of the computing devices described herein (e.g., the provider computing system 105, the one or more user devices 140, the one or more third-party systems 170, etc.) may also communicate wirelessly with the computing devices of the network 101 via a proxy device (e.g., a router, network switch, or gateway). In some embodiments, a wired or a combination of wired and/or wireless connections may be used to enable communicable coupling.

The system 100 is shown to include a plurality of user devices 140. The user device 140 may be owned by, managed by, and/or otherwise associated with a user. As the provider is a travel experience provider, in this example, the user may be an agent or analyst employed by the provider organization. Specifically, the user may be a fraud detection analyst. The user device 140 can include one or more computing devices that can perform various operations as described herein. For example, in some implementations, the user device 140 may be or may include, for example, a desktop or laptop computer (e.g., a tablet computer), a smartphone, a wearable device (e.g., a smartwatch), a personal digital assistant, and/or any other suitable computing device. In the example shown, the user device 140 is structured as a computing device, namely a desktop or laptop computer. In various embodiments, the user device 140 may be utilized by a customer of the provider organization. For example, a customer may access a website of the provider organization and access an account associated with the provider organization. The customer may be able to view transactions associated with their account. If a customer sees a transaction associated with their account, the user may report the transaction as potentially fraudulent.

Each of the user devices 140 can include at least one processing circuit 142, at least one processor (e.g., processor(s) 150), and at least one memory (e.g., memory 155). The memory 155 may, as an example, include at least one client application (e.g., client application 145) and the machine learning model 135. In some implementations, one or more of the user devices 140 can access various functions of the provider computing system 105 through the network 101. For example, the user device 140 can access one or more functions of the provider computing system 105 via the client application 145 of the user device 140 that is configured to display various user interfaces to the user device 140 via the network 101. In some embodiments, the user device 140 may include the machine learning models 135, as described herein.

The client application 145 can be coupled to and supported, at least partly, by the provider computing system 105. For example, in operation, the client application 145 can be communicably coupled to the provider computing system 105 and may perform certain operations described herein. In some embodiments, the client application 145 includes program logic stored in a system memory (e.g., memory 155) of the user device 140. In such arrangements, the program logic may configure a processor (e.g., processor(s) 150) of the user device 140 to perform at least some of the functions discussed herein with respect to the client application 145 of the user device 140. In the example shown, the client application 145 may be downloaded from an application store, stored in the memory 155 of the user device 140, and selectively executed by the processor(s) 150. In other embodiments, the client application 145 may be hard-coded into the user device 140. In still various other embodiments, the client application 145 is a web-based application. As alluded to above, the client application 145 may be provided by the provider associated with the provider computing system 105 such that the client application 145 supports at least some of the functionalities and operations described herein with respect to the provider computing system 105. In this way, the client application 145 may also be referred to as a provider institution client application or provider client application. In some embodiments, the client application 145 may be accessed and executed by the processor(s) 150 responsive to receiving various credentials of a user to access the client application 145 (e.g., a username, a password, a pin code, a biometric such as a facial scan or a fingerprint, a combination thereof, etc.).

In some instances, the client application 145 may additionally be coupled to the third-party system(s) 170 (e.g., via one or more application programming interfaces (APIs) and/or software development kits (SDKs)) to integrate one or more features or services provided by the third-party system(s) 170. In some instances, the third-party system(s) 170 may alternatively and/or additionally provide services via a separate client application 145. For example, the client application 145 may initiate an API call to the third-party system 170 to retrieve API information for use as training data 130 for the machine learning model 135.

The processor(s) 150 can include a microprocessor, an ASIC, an FPGA, a GPU, a TPU, etc., or combinations thereof. The memory 155 can store processor-executable instructions that, when executed by the processor(s) 150, cause the processor(s) 150 to perform one or more of the operations described herein. The memory 155 can include, but is not limited to, electronic, optical, magnetic, or any other storage or transmission device capable of providing the processor 150 with program instructions. The memory 155 can further include a memory chip, ROM, RAM, EEPROM, EPROM, flash memory, optical media, or any other suitable memory from which the processor(s) 150 can read instructions. The instructions can include code from any suitable computer programming language.

The user device 140 is further shown as including an I/O device 160 and a network interface 165. The I/O device 160 can include various components for receiving inputs, providing outputs, or receiving and providing inputs and outputs, respectively, to a user of the user device 140. For example, the I/O device 160 can include a display screen such as a touchscreen, a mouse, a button, a keyboard, a microphone, a speaker, an accelerometer, actuators (e.g., vibration motors), any combination thereof, etc. The I/O device 160 may also include circuitry/programming/etc. for operating such components. The I/O device 160 thereby enables communications to and from a user, for example communications relating to travel recommendations as described in further detail herein.

The network interface 165 includes, for example, program logic and various devices and/or components and systems (e.g., transceivers, etc.) that connect the user device 140 to the network 101. The network interface 165 facilitates secure communications between the user device 140 and each of the provider computing system 105 and/or the third-party system 170. The network interface 165 also facilitates communication with other entities, such as other providers of goods and/or services.

The system 100 is shown to include the third-party system 170 (although only one is shown, there could be a plurality or, in some embodiments, none). The third-party system or third-party computing system 170 may be a third party relative to the provider and may be associated with a third-party entity. For example, the third-party entity may be or may include various goods and/or services provider entities including, but not limited to, a transportation provider (e.g., airline, car service, etc.), a lodging provider (e.g., hotel, rental property, cruise, etc.), an experience provider (e.g., theme parks, concerts, shows, events, excursions, etc.), or any combination thereof. The provider computing system 105 may communicate with the third-party system 170 to make bookings and reserve experiences on behalf of the traveler/user. The third-party system 170 includes a respective network interface 175 to facilitate exchanging data with the provider computing system 105 and/or the user device 140 through the network 101. The third-party system 170 may include one or more servers. The third-party system 170 may include one or more APIs and/or SDKs associated with the third-party entity for exchanging data with the provider computing system 105 and/or the user device 140, as described herein.

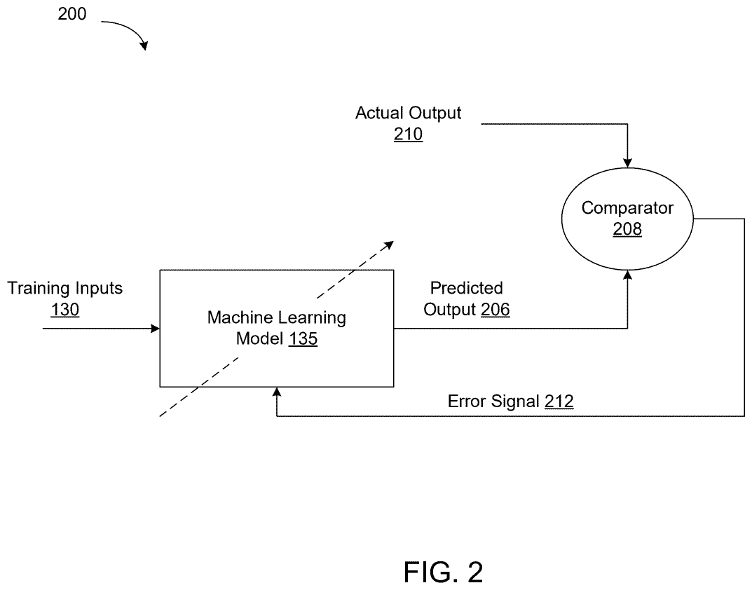

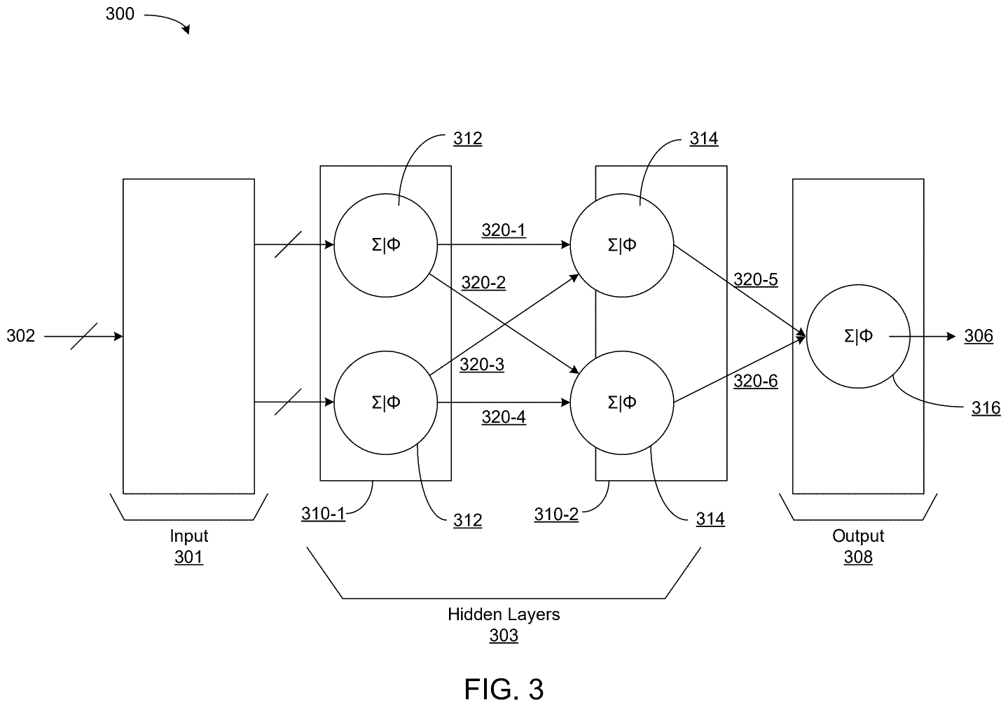

The machine learning model 135 may be structured to recognize patterns, trends, and the like in data and make one or more determinations. In some embodiments, the machine learning model 135 may be or include a predictive AI model and/or a generative AI model, both of which are described herein. For example, FIGS. 2 and 3 represent example structures of the machine learning model 135. The machine learning model 135 may utilize, as an input, a fraud document. The fraud document may include the transaction to be reviewed and corresponding details, as described above. The input may be referred to as a “prompt.” The machine learning model 135 may generate, as an output, a narrative including factors or information found in the input document(s) indicative of whether the transaction is fraudulent or not. The machine learning model 135 may also generate, as an output, a preliminary determination of whether the transaction is fraudulent that may be further reviewed by an analyst.

Referring to FIG. 2, a block diagram of an example system AI system 200 using supervised learning is shown, according to an example embodiment. Supervised learning is a method of training a machine learning model given input-output pairs. An input-output pair is an input with an associated known output (e.g., an expected output).

Machine learning model 135 may be trained on known input-output pairs such that the machine learning model 135 can learn how to predict known outputs given known inputs. This may be referred to as a “training phase.” During the training phase, the machine learning model 135 may utilize training data 130 to be able to generate outputs (e.g., classifications of fraud and/or narratives indicating data indicative of fraud) from unknown inputs during an inference phase. Thus, once the machine learning model 135 has learned how to predict known input-output pairs, the machine learning model 135 can operate on unknown inputs to predict an output. For example, the machine learning model 135 may receive data relating to potentially fraudulent transactions made by a plurality of users on the provider computing system. The machine learning model 135 may classify the transactions as having a high, moderate, or low likelihood of being fraudulent (e.g., performs the operations described with respect to the fraud assessor 132). Responsive to classifying transactions as having a moderate or low likelihood of being fraudulent, the machine learning model 135 may further review the transactions to generate a narrative including indicators of fraud and, in some embodiments, a preliminary determination of whether the transaction is fraudulent. The reviewed transactions may then be given to a fraud analyst for final review and/or confirmation of the decision generated by the machine learning model 135.

The machine learning model 135 may be trained based on general data and/or granular data (e.g., data based on a specific user) such that the machine learning model 135 may be trained specific to a particular user. For example, the machine learning model 135 implemented on a user device 140 belonging to a specific analyst may be trained based on fraud determinations made by that specific analyst (e.g., training data 130 includes narratives generated by a particular fraud analyst). The machine learning model 135 may be, for example, an in-house LLM (e.g., an LLM designed for use specifically at the provider organization and by users or employees of the provider organization) or other in-house machine learning model. The machine learning model 135 may utilize a base LLM (e.g., Llama-7B or another base LLM). The base LLM may utilize training data 130 and previous outputs to generate an instruct-tuned LLM (e.g., a machine learning model trained on data specific to the provider organization).

The machine learning model 135 may also receive raw transaction data for transactions performed via the provider organization. The machine learning model 135 may analyze the raw data and extract information that may be relevant to classifying a potentially fraudulent transaction and/or generating a narrative including characteristics of the transaction indicative of fraud. Thus, in various embodiments, training data 130 may include datasets that have previously been reviewed by the machine learning model 135 and have had relevant data extracted. Once the machine learning model 135 is trained on the previous datasets, the machine learning model 135 may receive raw data and identify relevant pieces of data for use in determining a likelihood of fraud and/or a narrative explaining the fraud indicators.

As stated above, the machine learning model 135 may utilize, as an input, a fraud document. The fraud document may include the transaction to be reviewed and corresponding details, as described above. The input may be referred to as a “prompt.” The prompt or input may include a plurality of components. For example, the input may include third party API data (e.g., search engine data for a specific property or location, ISP, bank, IP information, etc.), a generic instruction text instructing the machine learning model 135 to generate a narrative including indicators of fraud and/or a fraud determination, and an input of transaction data. The transaction data may be retrieved from the API. The information may be, for example, in a JSON payload format. The data may be generated in real time for every transaction performed on the provider computing system. The machine learning model 135 may generate, as an output, a narrative including factors or information found in the input document(s) used to make a determination of whether the transaction is fraudulent. The narrative may include the plurality of characteristics potentially relevant to whether the transaction is fraudulent. The narrative may include a natural language narrative including one or more natural language phrases and/or sentences. The machine learning model 135 may determine a form and content of the narrative for the transaction based at least in part on a form and content of the analysis notes from the training data 130. The machine learning model 135 may also generate, as an output, a preliminary determination of whether the transaction is fraudulent.

Training data 130 (also referred to as training inputs 130) and actual outputs 210 may be provided to the machine learning model 135. Training inputs 130 may include transactions previously classified as having a high, moderate, or low likelihood of being potentially fraudulent and associated information indicative of why the transaction has been classified in the way that is has. Training inputs 130 may also include data collected from Point of Sale, retrieved via an API, when a transaction performed by an external user of the provider computing system 105 occurs (e.g., when a user books a flight or vacation rental). The training data 130 may also include a plurality of previously reported and reviewed potentially fraudulent transaction, including verbatim narratives or reports generated by fraud analysts, and the like. Actual outputs 210 may be or include previous decisions made by the machine learning model 135. For example, actual outputs 210 may include transactions that the machine learning model 135 has previous classified as having a high, moderate, or low likelihood of being fraudulent, moderate to low likelihood transactions that have been determined to be fraudulent or not, narratives generated by the machine learning model 135 describing evidence supporting the fraud determination, and transactions in which the machine learning model 135 has abstained from classifying (e.g., has abstained from classifying as having a high, moderate, or low likelihood of fraud and/or has abstained from classifying a moderate or low likelihood transaction as being fraudulent).

The training data 130, inputs, and actual outputs 210 may be received from one or more data repositories. For example, a data repository may contain transactions (e.g., bookings, reservations, etc.) or other events (e.g., posting of rental house listings, login attempts, etc.). A data repository may also contain an instruction dataset (e.g., previously reviewed transactions, associated fraud decisions, and associated narratives). Thus, the machine learning model 135 may be trained to predict a classification of likelihood that a transaction is fraudulent, and, based on the transaction being classified as having a moderately to low likelihood of being fraudulent, whether the transaction is confirmed to be fraudulent based on the training inputs 130 and actual outputs 210 used to train the machine learning model 135.

The system 100 may include one or more machine learning models 135. In an embodiment, a first machine learning model 135 may be trained to predict one or more classifications of a potentially fraudulent transaction. For example, the first machine learning model 135 may be trained using the training inputs 130 (e.g., previously reviewed transactions that have been classified as having a high, moderate, or low likelihood of being fraudulent, previous transactions having a moderate or low likelihood of being fraudulent that have been further reviewed and determined to be fraudulent, previously generated narratives, fraud analyst narratives, etc.) to predict outputs 206 (e.g., transaction classification, fraudulence determination, narratives, etc.) by applying the current state of the first machine learning model 135 to the training inputs 130. The comparator 208 may compare the predicted outputs 206 to actual outputs 210 to determine an amount of error or differences. For example, for a given transaction that has been determined to be moderately likely to be fraudulent, a predicted determination that the transaction is fraudulent (e.g., predicted output 206) may be compared to an actual determination that the transaction is fraudulent (e.g., actual output 210).

Thus, in some embodiments, a single machine leaning model 135 may be trained to make one or more recommendations to the user based on current user data received from, for example, training data 130. That is, a single machine leaning model may be trained using the training inputs to predict a classification of a transaction as highly, moderately, or unlikely to be fraudulent and predict whether a moderately or unlikely fraudulent transaction is fraudulent by applying the current state of the machine learning model 135 to the training inputs 130. The comparator 208 may compare the predicted outputs 206 to actual outputs 210 to determine an amount of error or differences. The actual outputs 210 may be determined based on historic data associated with the predictions, narratives, classifications, etc., generated and provided to the user.

In other embodiments, a second machine learning model 135 may be trained to make one or more recommendations to the user based on the predicted output from the first machine learning model 135. For example, the first machine learning model 135 may utilize transactions previously classified as having a high, moderate, or low likelihood of being fraudulent as training inputs 130. The first machine learning model 135 may then solely receive potentially fraudulent transactions and classify them as having a high, moderate, or low likelihood of being fraudulent. The first machine learning model 135 may communicate transactions classified as having a moderate or low likelihood to the second machine learning model 135. The second machine learning model 135 may use previously reviewed moderate and low likelihood transactions, generated narratives, and fraud analyst comments as training inputs 130 to predict outputs 206, specifically whether a low or moderate likelihood transaction is fraudulent, by applying the current state of the second machine learning model 135 to the training inputs 130. The comparator 208 may compare the predicted outputs 206 to actual outputs 210 to determine an amount of error or differences. Once the second machine learning model 135 has been trained, the second machine learning model 135 may receive the classified transaction from the first machine learning model 135 and generate a narrative and/or a preliminary determination on fraudulence.

Once the machine learning model 135 has been sufficiently trained (e.g., the comparator 208 determines that an amount of error or differences is below a predefined threshold value), the machine learning model 135 may receive, as an input, in an inference phase, information relating to an unreviewed, potentially fraudulent transaction. For example, the machine learning model 135 may receive a prompt including the elements described above (e.g. a note, an instruction, and an input). The machine learning model 135 may classify the transaction and/or generate an output, using the information from the input, including, for example, a narrative including indicators of fraud from the transaction data and a preliminary determination of fraudulence. In various embodiments, the output by the first machine learning model 135 may be forwarded to and reviewed by a fraud analyst.

In various embodiments, a first machine learning model 135 may receive, as an input, a transaction and details relating to a transaction that has been classified as having a moderate to low likelihood of being fraudulent. The first machine learning model 135 may perform a search to retrieve relevant documents from an internal source, such as a database provided by the provider. Relevant documents may include, for example, similar transactions that have been previously reviewed by the machine learning model 135 and/or a fraud analyst. The first machine learning model 135 may then generate a response including a narrative with indicators indicative of fraud. The response may also include a determination of whether the transaction is fraudulent or not. The narrative may include reasons as to why the transaction was classified as fraudulent or not using evidence from the transaction details. For example, the narrative may include that there is evidence of a mismatch between payment/cardholder information compared to traveler, device, and flightpath details for a booked flight. This information may be included in the transaction details received by the first machine learning model 135. The narrative and determination may be communicated to a fraud analyst for review. The fraud analyst may decide whether to accept the output from the first machine learning model 135 as a final decision on the fraudulence of the transaction or to utilize a second machine learning model 135 to receive more information prior to making a final determination on the fraudulence of the transaction.

In various embodiments, the second machine learning model 135 may be a conversational LLM or chatbot (e.g., ChatGPT). A fraud analyst may converse with or query the second machine learning model 135 to retrieve additional information/context from, for example, websites or other Internet sources, using one or more search engine APIs. The second machine learning model 135 may summarize the information and return the information to the fraud analyst for use as additional context for fraud determination. The information returned by the second machine learning model 135 may be used as an additional input to the first machine learning model, which may generate an updated narrative.

The actual outputs 210 may be determined based on historic data of recommendations made to the user. For example, the actual outputs of the machine learning model 135 may be based on previously reviewed transactions and previously generated narratives.

During training, the error (represented by error signal 212) determined by the comparator 208 may be used to adjust the weights in the machine learning model 135 such that the machine learning model 135 changes (or learns) over time. The machine learning model 135 may be trained using a backpropagation algorithm, for instance. The backpropagation algorithm operates by propagating the error signal 212. The error signal 212 may be calculated each iteration (e.g., each pair of training inputs 130 and associated actual outputs 210), batch and/or epoch, and propagated through the algorithmic weights in the machine learning model 135 such that the algorithmic weights adapt based on the amount of error. The error is minimized using a loss function. Non-limiting examples of loss functions may include the square error function, the root mean square error function, and/or the cross-entropy error function.

The weighting coefficients of the machine learning model 135 may be tuned to reduce the amount of error, thereby minimizing the differences between (or otherwise converging) the predicted output 206 and the actual output 210. The machine learning model 104 may be trained until the error determined at the comparator 208 is within a certain threshold (or a threshold number of batches, epochs, or iterations have been reached). The trained machine learning model 135 and associated weighting coefficients may subsequently be stored in memory 155 or other data repository (e.g., a database) such that the machine learning model 135 may be employed on unknown data (e.g., not training inputs 130). Once trained and validated, the machine learning model 135 may be employed during a testing (or an inference phase). During testing, the machine learning model 135 may ingest unknown data to predict future data (e.g., future narratives, future fraud determinations, and the like).

In some embodiments, the AI system 200 may include or be coupled with one or more machine learning models 135. A first machine learning model 135 can include one or more neural networks, including, but not limited to, neural networks configured as generative models. For example, the first machine learning model 135 can predict or generate new data (e.g., artificial data; synthetic data; data not explicitly represented in the training inputs 202 and/or the actual outputs 210 used for configuring the first machine learning model 135). The first machine learning model 135 can generate any of a variety of modalities of data, such as text, speech, audio, images, and/or video data. As described below with reference to FIG. 3, the neural network model 300 can include a plurality of nodes (312, 314 and 316), which may be arranged in layers for providing outputs of one or more nodes of one layer as inputs to one or more nodes of another layer. The neural network can include one or more input layers (e.g., input layer 301), one or more hidden layers (e.g., hidden layers 310), and one or more output layers (e.g., output layers 308). Each node can include or be associated with parameters such as weights, biases, and/or thresholds, representing how the node can perform computations to process inputs to generate outputs. The parameters of the nodes can be configured by various learning or training operations, such as unsupervised learning, weakly supervised learning, semi-supervised learning, or supervised learning.

The first machine learning model 135 can include, for example and without limitation, one or more language models, LLMs, attention-based neural networks, transformer-based neural networks, generative pretrained transformer (GPT) models, bidirectional encoder representations from transformers (BERT) models, encoder/decoder models, sequence to sequence models, autoencoder models, generative adversarial networks (GANs), convolutional neural networks (CNNs), recurrent neural networks (RNNs), diffusion models (e.g., denoising diffusion probabilistic models (DDPMs)), or various combinations thereof.

Referring further to FIG. 2, the AI system 200 can configure the first machine learning model 135 to determine one or more second machine learning models 135. For example, the AI system 200 can include a model updater that configures (e.g., trains, updates, modifies, fine-tunes, etc.) the first machine learning model 135 to determine the one or more second machine learning model 135. In some implementations, the second machine learning model 135 can be used to provide application-specific outputs, such as outputs having greater precision, accuracy, or other metrics, relative to the first machine learning model 135, for targeted applications.

The second machine learning model 135 can be similar to the first machine learning model 135. For example, the second machine learning model 135 can have a similar or identical backbone or neural network architecture as the first machine learning model 135. In some implementations, the first machine learning model 135 and the second machine learning model 135 each include generative AI machine learning models, such as LLMs (e.g., GPT-based LLMs) and/or diffusion models. The second machine learning model 135 can be configured using processes analogous to those described for configuring the first machine learning model 135.

In some implementations, the model updater can perform operations on at least one of the first machine learning model 135 or the second machine learning model 135 via one or more interfaces, such as application programming interfaces (APIs). For example, the one or more machine learning models 135 can be operated and maintained by one or more systems separate from the provider computing system 105 (e.g., by the user device 140, as shown in FIG. 1). The model updater can provide training data to the first machine learning model 135, via the API, to determine the second machine learning model 135 based on the first machine learning model 135 and the training data 130. The model updater can control various training parameters or hyperparameters (e.g., learning rates, etc.) by providing instructions via the API to manage configuring the second machine learning model 135 using the first machine learning model 135.

The model updater can perform various machine learning model configuration/training operations to determine the second machine learning model 135 using the data from the training data 130, as described above. For example, the model updater can perform various updating, optimization, retraining, reconfiguration, fine-tuning, or transfer learning operations, or various combinations thereof, to determine the second machine learning model 135. The model updater can configure the second machine learning model 135, using the training data 130, to generate outputs (e.g., recommendations) in response to receiving inputs (e.g., prompts), where the inputs and outputs can be analogous to data of the training data 130 (e.g., training inputs 202 and actual outputs 210).

For example, the model updater can identify one or more parameters (e.g., weights and/or biases) of one or more layers of the first machine learning model 135, and maintain (e.g., freeze, maintain as the identified values while updating) the values of the one or more parameters of the one or more layers. In some implementations, the model updater can modify the one or more layers, such as to add, remove, or change an output layer of the one or more layers, or to not maintain the values of the one or more parameters. The model updater can select at least a subset of the identified one or parameters to maintain according to various criteria, such as user input or other instructions indicative of an extent to which the first machine learning model 135 is to be modified to determine the second machine learning model 135. In some implementations, the model updater can modify the first machine learning model 135 so that an output layer of the first machine learning model 135 corresponds to output to be determined.

Responsive to selecting the one or more parameters to maintain, the model updater can apply, as input to the second machine learning model 135 (e.g., to a candidate second machine learning model 135, such as the first machine learning model 135 having the identified parameters maintained as the identified values), training data (e.g., from the training data 130). For example, the model updater can apply the training data 130 as input to the second machine learning model 135 to cause the second machine learning model 135 to generate one or more candidate outputs.

The model updater can evaluate a convergence condition to modify the candidate second machine learning model 135 based at least on the one or more candidate outputs and the training data applied as input to the candidate second machine learning model 135. For example, the model updater can evaluate an objective function of the convergence condition, such as a loss function (e.g., L1 loss, L2 loss, root mean square error, cross-entropy or log loss, etc.) based on the one or more candidate outputs and the training data; this evaluation can indicate how closely the candidate outputs generated by the candidate second machine learning model 135 correspond to the ground truth represented by the training data 130. The model updater can use any of a variety of optimization algorithms (e.g., gradient descent, stochastic descent, Adam optimization, etc.) to modify one or more parameters (e.g., weights or biases of the layer(s) of the candidate second machine learning model 135 that are not frozen) of the candidate second machine learning model 135 according to the evaluation of the objective function. In some implementations, the model updater can use various hyperparameters to evaluate the convergence condition and/or perform the configuration of the candidate second machine learning model 135 to determine the second machine learning model 135, including but not limited to hyperparameters such as learning rates, numbers of iterations or epochs of training, etc.

Referring now to FIG. 3, a block diagram of a simplified neural network model 300 is shown. The neural network model 300 may include a stack of distinct layers (vertically oriented) that transform a variable number of inputs 302 being ingested by an input layer 304, into an output 306 at the output layer 308.

The neural network model 300 may include a number of hidden layers 310 between the input layer 304 and output layer 308. Each hidden layer has a respective number of nodes (312, 314 and 316). In the neural network model 300, the first hidden layer 310-1 has nodes 312, and the second hidden layer 310-2 has nodes 314. The nodes 312 and 314 perform a particular computation and are interconnected to the nodes of adjacent layers (e.g., nodes 312 in the first hidden layer 310-1 are connected to nodes 314 in a second hidden layer 310-2, and nodes 314 in the second hidden layer 310-2 are connected to nodes 316 in the output layer 308). Each of the nodes (312, 314 and 316) sum up the values from adjacent nodes and apply an activation function, allowing the neural network model 300 to detect nonlinear patterns in the inputs 302. Each of the nodes (312, 314 and 316) are interconnected by weights 320-1, 320-2, 320-3, 320-4, 320-5, 320-6 (collectively referred to as weights 320). Weights 320 are tuned during training to adjust the strength of the node. The adjustment of the strength of the node facilitates the neural network's ability to predict an accurate output 306.

In some embodiments, the output 306 may be one or more numbers. For example, output 306 may be a vector of real numbers subsequently classified by any classifier. In one example, the real numbers may be input into a softmax classifier. A softmax classifier uses a softmax function, or a normalized exponential function, to transform an input of real numbers into a normalized probability distribution over predicted output classes. For example, the softmax classifier may indicate the probability of the output being in class A, B, C, etc. As, such the softmax classifier may be employed because of the classifier's ability to classify various classes. Other classifiers may be used to make other classifications. For example, the sigmoid function, makes binary determinations about the classification of one class (i.e., the output may be classified using label A or the output may not be classified using label A).

It is noted that various other forms of classifiers may be implemented or used in the present disclosure (e.g., in the machine learning model 135). For example, the machine learning model 135 described herein may include or use a support vector machine, random forest, K-nearest neighbors, naïve bayes, or any other type or form of classifier.

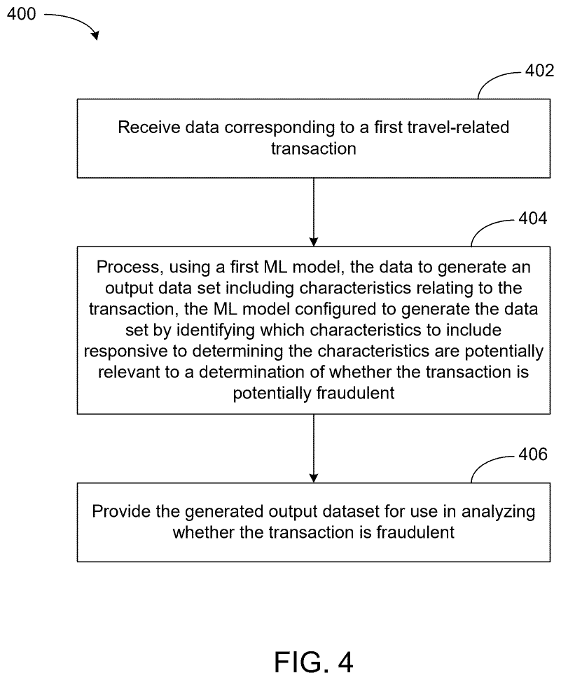

Based on the foregoing, referring now to FIG. 4, a flowchart of a method 400 for automated fraud risk reduction for travel-related transactions is shown, according to an example embodiment.

At process 402, the provider computing system 105 may receive data corresponding to a first travel-related transaction. In various embodiments, the first travel-related transaction may be an accommodation reservation. In various embodiments, the first travel-related transaction may be a listing of a property.

At process 404, the provider computing system 105 may process the data. in various embodiments, the provider computing system 105 may utilize a first machine learning model (e.g., a first machine learning model 135) to process the data. Upon processing the data, the first machine learning model may generate an output data set. The output dataset may include a plurality of characteristics relating to the first travel-related transaction. The first machine learning model may generate the output dataset by identifying which of the plurality of characteristics to include. The plurality of characteristics to include may be identified responsive to the first machine learning model determining that the plurality of characteristics are potentially relevant to a determination of whether the first travel-related transaction is fraudulent. For example, the first machine learning model may process the data received at process 402 to identify a plurality of characteristics of the data. The first machine learning model may then determine that the plurality of characteristics are potentially relevant to a determination of whether the first travel-related transaction is fraudulent. Upon determining that the plurality of characteristics are potentially relevant to a fraud determination, the first machine learning model may identify which of the plurality of characteristics should be utilized in generating the output data set.

In various embodiments, the first machine learning model may be a generative artificial intelligence model. In various embodiments, when the first travel-related transaction is an accommodation reservation, the plurality of characteristics may include at least one of a location of the reservation or a location of a device used to make the reservation. In various embodiments, when the first travel-related transaction is a listing of a property, the plurality of characteristics may include at least one of a location of the property, a location of a host of the property, or a bank location of the host.

In various embodiments, the first machine learning model and/or a second machine learning model may classify a likelihood of the first travel-related transaction being fraudulent. In various embodiments, the first machine learning model and/or the second machine learning model may be a generative artificial intelligence model.

In various embodiments, the generated output data set may include a narrative including the plurality of characteristics potentially relevant to whether the first travel-related transaction is fraudulent. In various embodiments, the narrative may include a natural language narrative including one or more natural language phrases and/or sentences.

In various embodiments, the first machine learning model and/or another component of the provider computing system 105 may train the first machine learning model using a training data set relating to a plurality of historical travel-related transactions. The training data set may include classifications of the historical travel-related transactions as fraudulent or not fraudulent. The training data set may also include analysis notes from human analysts for the historical travel-related transactions, including natural language explanations relating to why the historical travel-related transactions were classified as fraudulent or not fraudulent. The first machine learning model may also determine a form and content of the narrative for the first travel-related transaction based at least in part on a form and content of the analysis notes from the training data set.

At process 406, the first machine learning model 135 may provide the generated output data set for use in analyzing whether the first travel-related transaction is fraudulent.

In various embodiments, the provider computing system 105 may further train the first machine learning model using a training data set relating to a plurality of historical travel-related transactions. The training data set may include classifications of the historical travel-related transactions as fraudulent or not fraudulent. The training data set may also include analysis notes for the historical transactions relating to why the historical first travel-related transaction transactions were classified as fraudulent or not fraudulent. The analysis notes may include a plurality of characteristics relating to properties or services being offered as part of the historical travel-related transactions, entities offering the properties or services as part of the historical travel-related transactions, entities accepting the offers of the properties or services as part of the historical travel-related transactions, and/or financial information relating to the historical travel-related transactions.

In various embodiments, the first machine learning model may automatically initiate an action for processing the first travel-related transaction based on the classified likelihood of the first travel-related transaction being fraudulent. The first machine learning model may classify the likelihood of the first travel-related transaction being fraudulent using a first threshold. The provider computing system 105 may automatically approve the first travel-related transaction without human review responsive to the likelihood of the first travel-related transaction being fraudulent being classified as below the first threshold.

In various embodiments, the first machine learning model may classify the likelihood of the first travel-related transaction being fraudulent using a first threshold. The first machine learning model may provide the generated output data set to an analyst for human review responsive to the likelihood of the first travel-related transaction being fraudulent being classified as above the first threshold.

In various embodiments, the first machine learning model may classify the likelihood of the first travel-related transaction being fraudulent using a second threshold higher than the first threshold. The first machine learning model may block the first travel-related transaction or move the first travel-related transaction into a queue for later processing responsive to the likelihood of the first travel-related transaction being fraudulent being classified as above the second threshold.

In various embodiments, the generated output data set may be provided to an analyst. A second machine learning model may provide or be configured to provide an automated chatbot for use by the analyst. The second machine learning model may generate additional information relating to the first travel-related transaction using input from the analyst provided via the chatbot. The first machine learning model may generate, using the additional information, an updated output data set including a second plurality of characteristics potentially relevant to a determination of whether the first travel-related transaction is fraudulent. The second machine learning model may automatically provide the updated output data set to the analyst via the automated chatbot.

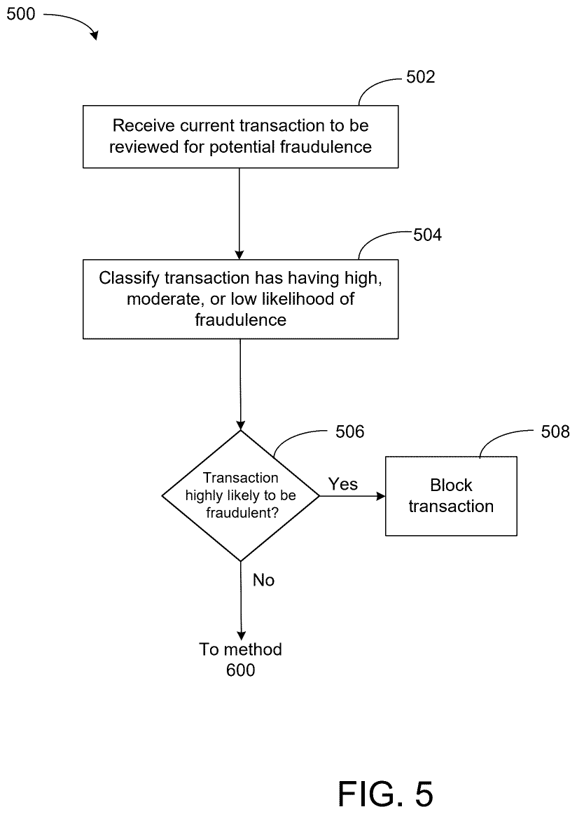

Based on the foregoing, referring now to FIG. 5, a flowchart of a method 500 of classifying a potentially fraudulent transaction as having a high, moderate, or low likelihood of being fraudulent is shown, in accordance with one or more implementations. Although the operations of the method 500 are described as being performed by various portions of the system 100 (e.g., the provider computing system 105, the machine learning system 135), it should be understood that the method 500 may be executed using any suitable computing system (e.g., the provider computing system 105 of FIG. 1, the user device 140 of FIG. 1, the third-party system 170 of FIG. 1, etc.). It may be appreciated that certain steps of the method 500 may be executed in parallel (e.g., concurrently) or sequentially. It may also be appreciated that while certain acts of the method 500 are shown as being performed by a specific device, some acts may be performed by another device of the system 100 in FIG. 1.

Although not shown in FIG. 5, the method 500 may begin when a fraudster or other cybercriminal performs a fraudulent act or transaction (e.g., creates a fraudulent listing, makes a reservation using another's account, etc.). A user may report the fraudulent act or transaction to the provider organization as potentially fraudulent. For example, the user may flag a transaction made on an account of the user associated with the provider organization that has not actually been performed by the user (e.g., a fraudster books a hotel using the user's account). The reported transaction may be added to a queue of transactions to be reviewed for fraud by the machine learning model 135 and a fraud analyst.

The method 500 may include act, operation, or process 502 in which the machine learning model 135 receives a transaction to be reviewed for potential fraudulence. At process 502, the machine learning model 135 may receive the transaction and additional details corresponding to the transaction. Specifically, the machine learning model 135 may receive a note, instruction, and input corresponding to the “prompt” described above with respect to FIG. 2. Details may be or include, for example, a date and time of the transaction, a date and time for the reservation (e.g., a date and time for a fraudulently booked flight), a cardholder's zip code, a cardholder's booking location, device information such as a browser language, device identifier, IP address, operating system, VPN, and user account details such as email address, name, etc. If the transaction is a potentially fraudulent listing, details may be or include a property/listing location, a host location, a bank location of the account holder, a security phone number, a host phone number, etc.

At process 504, the machine learning model 135 may classify the transaction as having a high, moderate, or low likelihood of being fraudulent. The machine learning model 135 may classify the transaction based on reviewing the transaction details received at process 502. Details may be associated with different indicators indicating a level of likeliness of fraud. For example, a listing for a rental home in a continent different than the location of the host may be associated with a high likelihood of fraudulence. The machine learning model 135 may classify the transaction based on an estimated risk of fraud. The estimated risk of fraud may be determined based on a type of indicator indicative of fraud and/or a number of details indicative of fraud. For example, if the number of potential fraud indicators or type of potential fraud indicator(s) is less than a first predetermined threshold value, the machine learning model 135 may classify the transaction as having a low likelihood of being fraudulent. If the number of potential fraud indicators or a type of potential fraud indicator(s) is greater than or equal to the first predetermined threshold value but less than a second predetermined threshold value, the machine learning model 135 may classify the transaction as having a moderate likelihood of being fraudulent. If the number of potential fraud indicators or a type of potential fraud indicator(s) is greater than the second predetermined threshold value, the machine learning model 135 may classify the transaction as having a high likelihood of being fraudulent.

In various embodiments, the machine learning model 135 may classify the transactions based on a type of one or more potential fraud indicators. For example, a transaction that is classified as having a high likelihood of being fraudulent may have a number of potential fraud indicators less than the second predetermined threshold value, but the potential fraud indicators may be determined to be highly indicative of potential fraud. In various embodiments, the machine learning model 135 may classify the transactions based on both a type of the potential fraud indicators and a number of identified potential fraud indicators.

At process 506, the machine learning model 135 may determine whether the transaction has been determined to be highly likely to be fraudulent. Responsive to the transaction being deemed highly likely to be fraudulent, the transaction 135 may be blocked or otherwise prevented, as shown at process 508. Blocking a transaction may include, for example, removing the fraudulent listing, canceling a fraudulently booked reservation, refunding a credit card that was fraudulently used, etc.

Responsive to the transaction not being deemed highly likely to be fraudulent (e.g., the transaction is deemed to have a moderate or low likelihood of being fraudulent), the method 500 may continue to the method 600, which will be described herein.

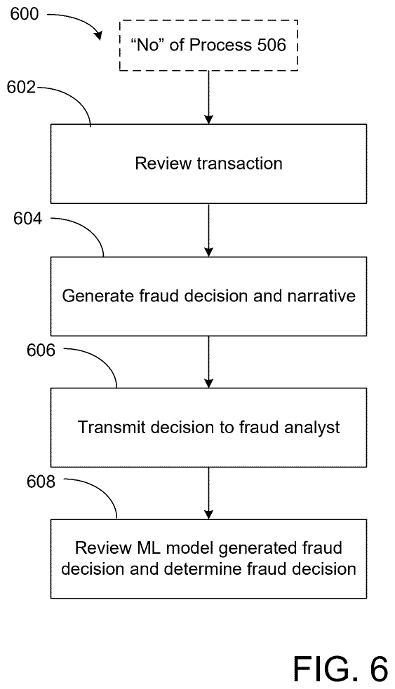

Referring now to FIG. 6, a method 600 is shown for reviewing potentially fraudulent transactions and determining whether the transaction is deemed to be fraudulent using a machine learning model, according to an example embodiment.

The method 600 may continue from process 506 of the method 500. Specifically, the method 600 may continue responsive to a determination that the transaction reviewed in the method 500 is not highly likely to be fraudulent (e.g., is determined to have a moderate or low likelihood of being fraudulent).

At process 602, the machine learning model 135 may review the transaction to determine whether the transaction is fraudulent. The machine learning model 135 may utilize, as inputs, the prompt including third party API data, an instruction text instructing the machine learning model 135 to generate a fraud determination, and an input of transaction data/details. Reviewing the transaction may include identifying, from the input, relevant information about the transaction that may be indicative of fraudulence. From the data, the machine learning model 135 may extract details that indicate fraud. For example, the machine learning model 135 may extract details indicating that a listing was posted for a city in Spain but the IP address of the user posting the listing is in China.

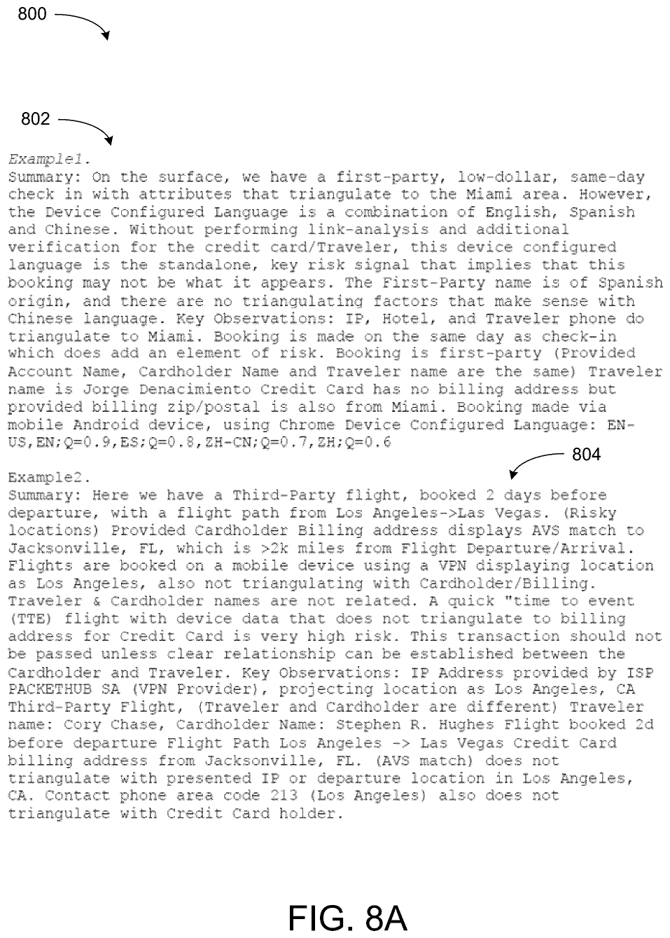

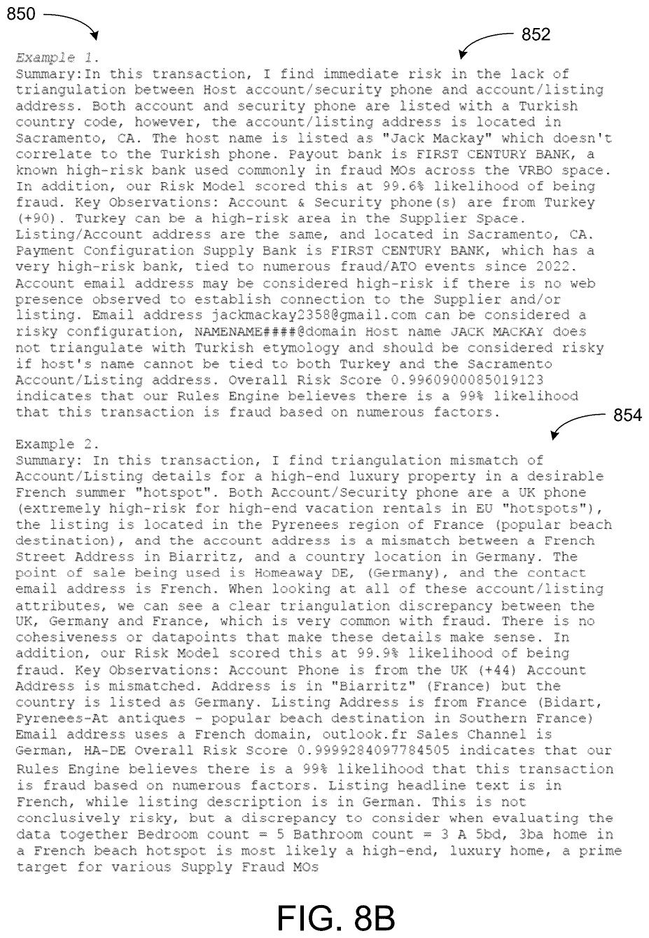

At process 604, the machine learning model 135 may generate a fraud decision and a narrative. The machine learning model 135 may also preliminarily determine that the transaction is fraudulent or is not fraudulent. The machine learning model 135 may also abstain from making a decision on the fraudulence of the transaction. For example, the machine learning model 135 may abstain from making a decision when there is a lack of sufficient information to utilize to generate a decision (e.g., there are no previously determined transactions having similar characteristics that the machine learning model 135 has been trained on, or the transactions details are too ambiguous for the machine learning model 135 to generate a narrative/determination). The machine learning model 135 may generate a narrative including one or more observations relating to the transaction details as to why the transaction is determined to be fraudulent or not. For example, the narrative may include an indication that the IP address of a user is different than a location of the listing they have posted. The narrative may be generated as a natural language narrative including one or more natural language phrases and/or sentences. An example narrative is described with respect to FIGS. 8A and 8B.

At process 606, the generated fraud decision and the corresponding narrative may be transmitted to the fraud analyst. The generated preliminary decision, the corresponding narrative, and the relevant transaction documents may be displayed on the user device 140 belonging to the fraud analyst. At process 608, the fraud analyst may review the decision made by the machine learning model 135 and determine a final decision on the fraudulence of the document. The fraud analyst may confirm or contest the decision made by the machine learning model 135 based on review of the transaction documents and the narrative generated by the machine learning model 135. When the machine learning model 135 abstains from making a decision, the fraud analyst may make a decision on the fraudulence of the transaction and may generate a corresponding narrative.

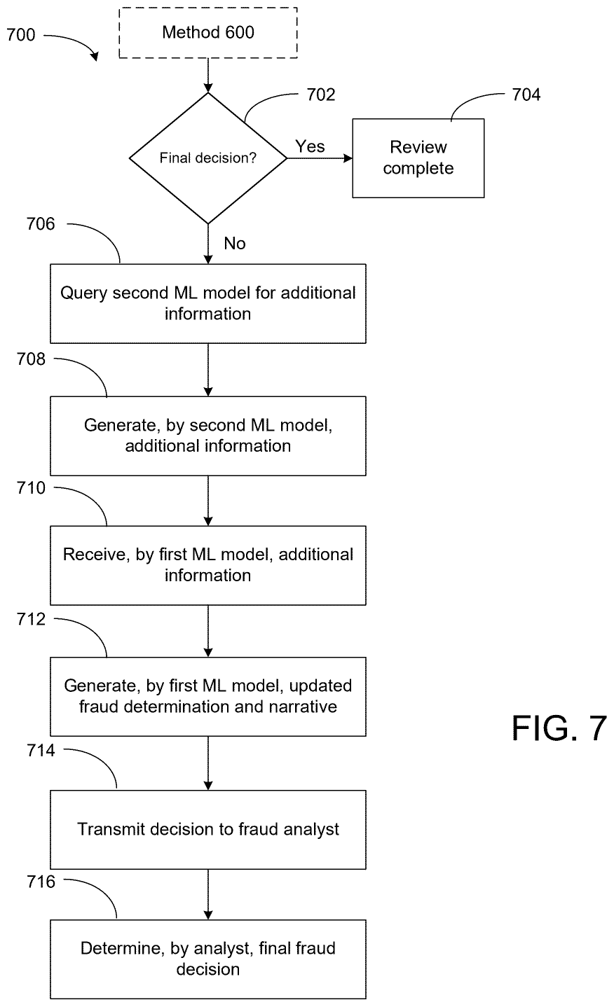

Referring now to FIG. 7, a method 700 is shown for reviewing potentially fraudulent transactions and determining whether the transaction is deemed to be fraudulent using a first machine learning model and a second machine learning model, according to an example embodiment. The second machine learning model may be configured as a conversational machine learning model (e.g., a chatbot). In some embodiments, the method 700 may occur responsive to the method 600 occurring. For example, the method 700 may occur responsive to the fraud analyst reviewing the generated decision determining a decision on the fraudulence of the transaction at step 608. In the method 700, the machine learning model 135 may be a first machine learning model 135.

At process 702, the decision made at step 608 by the fraud analyst may be determined to be a final decision. For example, the fraud analyst may determine whether the transaction can be considered fully reviewed. Responsive to the decision being final, at process 704, review of the transaction is complete. If the transaction has been determined to be fraudulent, actions may occur to block the transaction. For example, the actions may include removing a fraudulent listing, canceling a fraudulently booked reservation, refunding a credit card that was fraudulently used, etc. If the transaction has been determined to not be fraudulent, the analyst may close the review process and mark the transaction as reviewed.

Responsive to the decision not being final, at process 706, the fraud analyst may query (e.g., input a prompt or question) a second machine learning model 135. The analyst may query the second machine learning model 135 for additional information relating to the transaction. In various embodiments, the second machine learning model 135 may be a conversational chatbot (e.g., ChatGPT). The fraud analyst may query the second machine learning model 135 to retrieve information from a web page or other Internet resource via, for example, a search engine API.

At process 708, the second machine learning model 135 may retrieve the requested information via API. The second machine learning model 135 may also generate a narrative response summarizing the requested information.

At process 710, the first machine learning model 135 may receive the additional information generated by the second machine learning model 135. The first machine learning model 135 may utilize the additional information as an additional input to the machine learning model. The first machine learning model may again review the potentially fraudulent transaction, including the original prompt and the additional information from the second machine learning model as inputs.

At process 712, responsive to receiving the additional information, the first machine learning model 135 may generate an updated fraud determination and an updated narrative explaining the observations influencing the determination of the fraudulence of the transaction. In some embodiments, the additional information may confirm the decision previously made by the first machine learning model 135. In some embodiments, the additional information may cause the previous determination to be reversed. For example, the additional information may cause the first machine learning model 135 to reverse a previous determination that the transaction was fraudulent to a determination that the transaction was not fraudulent. In some embodiments, the additional information may cause the first machine learning model 135 to make a determination about the fraudulence of the transaction after previously abstaining from making a decision about the fraudulence of the transaction.

At process 714, responsive to the generation of the updated determination and the updated narrative, the machine learning model 135 may transmit the updated decision to the fraud analyst for review. At process 716, upon receipt of the updated decision and narrative, the fraud analyst may determine a final decision about the fraudulence of the transaction.

Referring now to FIGS. 8A and 8B, narratives generated by fraud analysts as shown, according to an example embodiment. The narratives generated by fraud analysts may include notes recorded by the analyst and include observations and key markers indicative of whether the transaction is fraudulent or not. The narratives written by the fraud analysts may be used as training data to the machine learning model 135 to train the machine learning model 135 to generate narrative outputs and preliminary determinations of fraudulence.

Referring specifically to FIG. 8A, example analyst narratives 800 are shown, according to an example embodiment. The analyst narratives 800 may be narratives written for potentially fraudulent bookings. The analyst narratives related to booking fraud may include, for example, evidence of one or more of: a short time to event after booking (e.g., departure date, check-in date), third party bookings, a discrepancy between a departure and destination, a card holder's zip code, and a card holder's booking location, a discrepancy between a traveler location and device information such as browser language, device ID, etc., a discrepancy between a customer's location or residence and a card holder's location, a usage of obsolete operating systems and/or VPN services, and a lack of similarity between an email address, email patterns, and a cardholder or traveler's name.

Referring specifically to FIG. 8B, example analyst narratives 850 are shown, according to an example embodiment. The analyst narratives 850 may be narratives written for potentially fraudulent listings. The analyst narratives related to listing fraud may include, for example, evidence of one or more of: a discrepancy between the property location and the host address (e.g. the property location is too far away from the host's location), an age of the property, a mismatch between an account holder's bank location and the property location, a discrepancy between a security phone number and host phone number, a geographically unrelated point of sale location and host residence/location or bank address mismatch, the host name being from different country than the property location, email addresses that are newly created, follow fraud patterns or contain evidence of fraud, and/or financial institutions with known previous fraudulent activities.

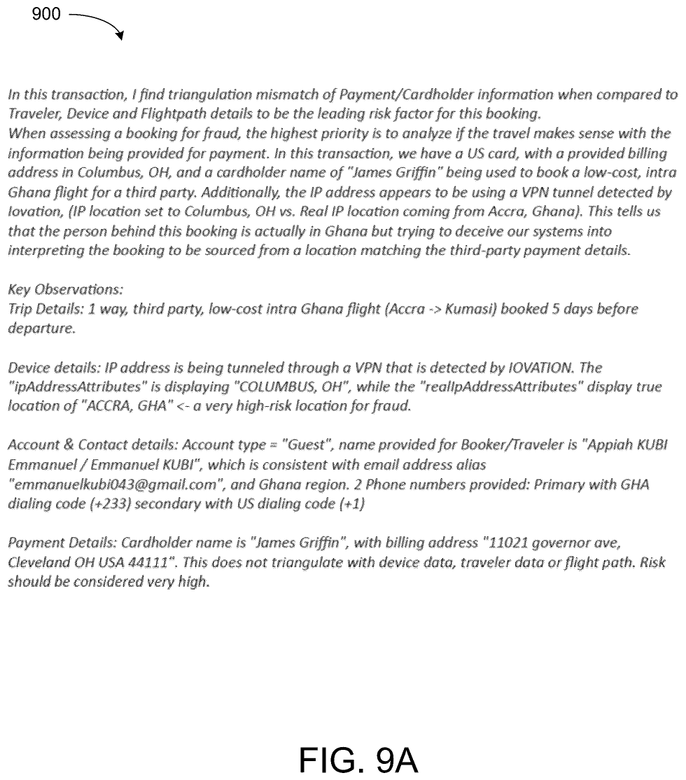

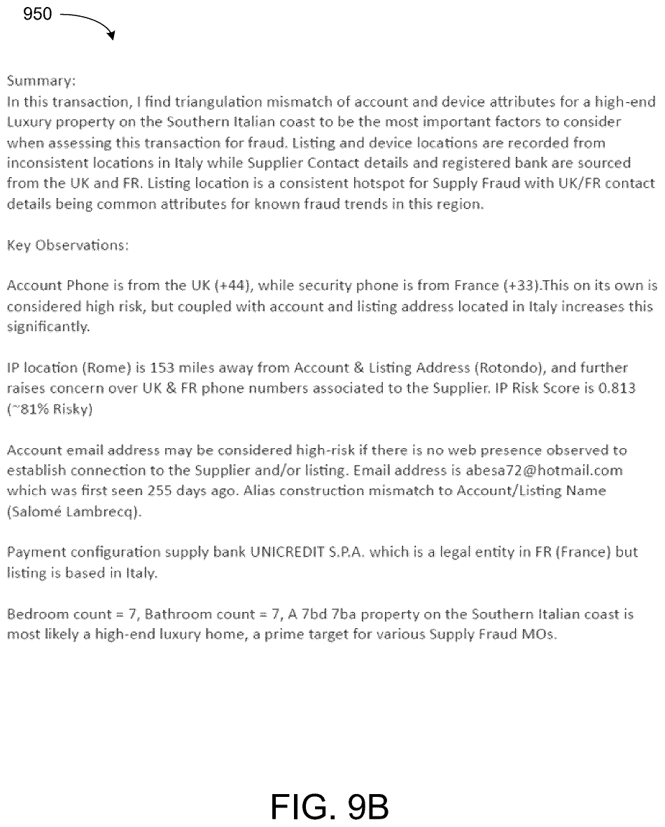

Referring now to FIGS. 9A and 9B, narratives generated by a machine learning model (e.g., machine learning model 135) are shown, according to an example embodiment. The machine learning model 135 may utilize narratives written by fraud analysts, such as the ones shown in FIGS. 8A and 8B, as training data to generate narrative outputs responsive to receiving transaction details about a previously unreviewed transaction. The narratives of FIGS. 9A and 9B may be generated in a natural language format.

Referring specifically to FIG. 9A, an example ML model narrative 900 is shown, according to an example embodiment. The ML model narrative 900 may be a narrative generated for a potentially fraudulent booking. The narrative 900 may include a paragraph-format summary of the observations made that indicate whether the transaction is fraudulent. The narrative 900 may also include one or more key observations that indicate fraud or not.

Referring specifically to FIG. 9B, an example ML model narrative 950 is shown, according to an example embodiment. The ML model narrative 950 may be a narrative generated for a potentially fraudulent listing. The model narrative 950 may include a paragraph-format summary of the observations and/or a list of the key observations made.

The term “coupled,” as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

The implementations described herein have been described with reference to drawings. The drawings illustrate certain details of specific implementations that implement the systems, methods, and programs described herein. Describing the implementations with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some implementations, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some implementations, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. In a non-limiting example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some implementations, the one or more processors may be embodied in various ways. The one or more processors may be constructed in a manner sufficient to perform at least the operations described herein. In some implementations, the one or more processors may be shared by multiple circuits (e.g., circuit A and circuit B may comprise or otherwise share the same processor, which, in some example implementations, may execute instructions stored, or otherwise accessed, via different areas of memory). Alternatively or additionally, the one or more processors may be structured to perform or otherwise execute certain operations independent of one or more co-processors.

In other example implementations, two or more processors may be coupled via a bus to enable independent, parallel, pipelined, or multi-threaded instruction execution. Each processor may be implemented as one or more processors, ASICs, FPGAs, GPUs, TPUs, digital signal processors (DSPs), or other suitable electronic data processing components structured to execute instructions provided by memory. The one or more processors may take the form of a single core processor, multi-core processor (e.g., a dual core processor, triple core processor, or quad core processor), microprocessor, etc. In some implementations, the one or more processors may be external to the apparatus, in a non-limiting example, the one or more processors may be a remote processor (e.g., a cloud-based processor). Alternatively or additionally, the one or more processors may be internal or local to the apparatus. In this regard, a given circuit or components thereof may be disposed locally (e.g., as part of a local server, a local computing system) or remotely (e.g., as part of a remote server such as a cloud-based server). To that end, a “circuit” as described herein may include components that are distributed across one or more locations.

An exemplary system for implementing the overall system or portions of the implementations might include general-purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile or non-volatile memories), etc. In some implementations, the non-volatile media may take the form of ROM, flash memory (e.g., flash memory such as NAND, 3D NAND, NOR, 3D NOR), EEPROM, MRAM, magnetic storage, hard disks, optical disks, etc. In other implementations, the volatile storage media may take the form of RAM, TRAM, ZRAM, etc. Combinations of the above are also included within the scope of machine-readable media. In this regard, machine-executable instructions comprise, in a non-limiting example, instructions and data, which cause a general-purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example implementations described herein.

It should also be noted that the term “input devices,” as described herein, may include any type of input device including, but not limited to, a keyboard, a keypad, a mouse, joystick, or other input devices performing a similar function. Comparatively, the term “output device,” as described herein, may include any type of output device including, but not limited to, a computer monitor, printer, facsimile machine, or other output devices performing a similar function.

It should be noted that although the diagrams herein may show a specific order and composition of method steps, it is understood that the order of these steps may differ from what is depicted. In a non-limiting example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative implementations. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps, and decision steps.

While this specification contains many specific implementation details, these should not be construed as limitations on the scope of any inventions or of what may be claimed, but rather as descriptions of features specific to particular implementations of the systems and methods described herein. Certain features that are described in this specification in the context of separate implementations may also be implemented in combination in a single implementation. Conversely, various features that are described in the context of a single implementation may also be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements, and features discussed only in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act, or element may include implementations where the act or element is based at least in part on any information, act, or element.

Any implementation disclosed herein may be combined with any other implementation, and references to “an implementation,” “some implementations,” “an alternate implementation,” “various implementations,” “one implementation,” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The foregoing description of implementations has been presented for purposes of illustration and description. It is not intended to be exhaustive or to limit the disclosure to the precise form disclosed, and modifications and variations are possible in light of the above teachings or may be acquired from this disclosure. The implementations were chosen and described in order to explain the principals of the disclosure and its practical application to enable one skilled in the art to utilize the various implementations and with various modifications as are suited to the particular use contemplated. Other substitutions, modifications, changes, and omissions may be made in the design, operating conditions, and implementation of the implementations without departing from the scope of the present disclosure as expressed in the appended claims.

What is claimed is:

1. A computing system for automated fraud risk reduction for travel-related transactions, the computing system comprising:
at least one processing circuit comprising at least one processor and at least one memory, the at least one memory storing instructions therein that, when executed by the at least one processor, cause the at least one processor to:
receive data corresponding to a first travel-related transaction;
process, using a first machine learning model, the data to automatically generate an output data set comprising a plurality of characteristics relating to the first travel-related transaction, the first machine learning model configured to generate the output data set by identifying the plurality of characteristics to include responsive to determining the plurality of characteristics are potentially relevant to a determination of whether the first travel-related transaction is fraudulent; and
provide the generated output data set for use in analyzing whether the first travel-related transaction is fraudulent.

2. The system of claim 1, wherein the instructions, when executed by the at least one processor, further cause the at least one processor to train the first machine learning model using a training data set relating to a plurality of historical travel-related transactions, the training data set comprising:
classifications of the historical travel-related transactions as fraudulent or not fraudulent; and
analysis notes for the historical transactions relating to why the historical first travel-related transaction transactions were classified as fraudulent or not fraudulent, the analysis notes comprising a plurality of characteristics relating to properties or services being offered as part of the historical travel-related transactions, entities offering the properties or services as part of the historical travel-related transactions, entities accepting the offers of the properties or services as part of the historical travel-related transactions, and/or financial information relating to the historical travel-related transactions.

3. The system of claim 1, wherein the instructions, when executed by the at least one processor, further cause the at least one processor to:
classify, by at least one of the first machine learning model or a second machine learning model, a likelihood of the first travel-related transaction being fraudulent.

4. The system of claim 3, wherein the instructions, when executed by the at least one processor, further cause the at least one processor to automatically initiate an action for processing the first travel-related transaction based on the classified likelihood of the first travel-related transaction being fraudulent.

5. The system of claim 4, wherein the at least one processor is configured to classify the likelihood of the first travel-related transaction being fraudulent using a first threshold, and wherein the instructions, when executed by the at least one processor, further cause the at least one processor to automatically approve the first travel-related transaction without human review responsive to the likelihood of the first travel-related transaction being fraudulent being classified as below the first threshold.

6. The system of claim 4, wherein the at least one processor is configured to classify the likelihood of the first travel-related transaction being fraudulent using a first threshold, and wherein the instructions, when executed by the at least one processor, further cause the at least one processor to provide the generated output data set to an analyst for human review responsive to the likelihood of the first travel-related transaction being fraudulent being classified as above the first threshold.

7. The system of claim 6, wherein the at least one processor is further configured to classify the likelihood of the first travel-related transaction being fraudulent using a second threshold higher than the first threshold, and wherein the instructions, when executed by the at least one processor, further cause the at least one processor to block the first travel-related transaction or move the first travel-related transaction into a queue for later processing responsive to the likelihood of the first travel-related transaction being fraudulent being classified as above the second threshold.

8. The system of claim 1, wherein the generated output data set is provided to an analyst, and wherein the instructions, when executed by the at least one processor, further cause the at least one processor to:
generate, using a second machine learning model configured to provide an automated chatbot for use by the analyst, additional information relating to the first travel-related transaction using input from the analyst provided via the chatbot;
generate, by the first machine learning model using the additional information, an updated output data set comprising a second plurality of characteristics potentially relevant to a determination of whether the first travel-related transaction is fraudulent.

9. The system of claim 8, wherein the instructions, when executed by the at least one processor, further cause the at least one processor to automatically provide the updated output data set to the analyst via the automated chatbot using the second machine learning model.

10. The system of claim 1, wherein the generated output data set comprises a narrative including the plurality of characteristics potentially relevant to whether the first travel-related transaction is fraudulent.

11. The system of claim 10, wherein the narrative comprises a natural language narrative comprising one or more natural language phrases and/or sentences.

12. The system of claim 11, the instructions, when executed by the at least one processor, further cause the at least one processor to train the first machine learning model using a training data set relating to a plurality of historical travel-related transactions, the training data set comprising:
classifications of the historical travel-related transactions as fraudulent or not fraudulent; and
analysis notes from human analysts for the historical travel-related transactions comprising natural language explanations relating to why the historical travel-related transactions were classified as fraudulent or not fraudulent;
wherein the at least one processor is configured to determine a form and content of the narrative for the first travel-related transaction based at least in part on a form and content of the analysis notes from the training data set.

13. The system of claim 1, wherein the first travel-related transaction is an accommodation reservation, and wherein the plurality of characteristics comprise at least one of a location of the reservation or a location of a device used to make the reservation.

14. The system of claim 1, wherein the first travel-related transaction is a listing of a property, and wherein the plurality of characteristics comprise at least one of a location of the property, a location of a host of the property, or a bank location of the host.

15. The system of claim 1, wherein the first machine learning model is a generative artificial intelligence model.

16. A method for automated fraud risk reduction for travel-related transactions, the method comprising:
receiving, by one or more processors, data corresponding to a first travel-related transaction;
processing, by the one or more processors, using a first machine learning model, the data to automatically generate an output data set comprising a plurality of characteristics relating to the first travel-related transaction, the first machine learning model configured to generate the output data set by identifying the plurality of characteristics to include responsive to determining the plurality of characteristics are potentially relevant to a determination of whether the first travel-related transaction is fraudulent; and
providing the generated output data set for use in analyzing whether the first travel-related transaction is fraudulent.

17. The method of claim 16, further comprising: training, by the one or more processors, the first machine learning model using a training data set relating to a plurality of historical travel-related transactions, the training data set comprising:
classifications of the historical travel-related transactions as fraudulent or not fraudulent; and
analysis notes for the historical transactions relating to why the historical first travel-related transaction transactions were classified as fraudulent or not fraudulent, the analysis notes comprising a plurality of characteristics relating to properties or services being offered as part of the historical travel-related transactions, entities offering the properties or services as part of the historical travel-related transactions, entities accepting the offers of the properties or services as part of the historical travel-related transactions, and/or financial information relating to the historical travel-related transactions.

18. The method of claim 16, wherein the generated output data set comprises a narrative including the plurality of characteristics potentially relevant to whether the first travel-related transaction is fraudulent.

19. One or more non-transitory computer readable storage media having instructions stored thereon that, upon execution by one or more processors to, cause the one or more processors to perform operations comprising:
receiving data corresponding to a first travel-related transaction;
processing, using a first machine learning model, the data to automatically generate an output data set comprising a plurality of characteristics relating to the first travel-related transaction, the first machine learning model configured to generate the output data set by identifying the plurality of characteristics to include responsive to determining the plurality of characteristics are potentially relevant to a determination of whether the first travel-related transaction is fraudulent; and
providing the generated output data set for use in analyzing whether the first travel-related transaction is fraudulent.

20. The one or more non-transitory computer readable storage media of claim 19, wherein the instructions further cause the one or more processors to train the first machine learning model using a training data set relating to a plurality of historical travel-related transactions, the training data set comprising:
classifications of the historical travel-related transactions as fraudulent or not fraudulent; and
analysis notes for the historical transactions relating to why the historical first travel-related transaction transactions were classified as fraudulent or not fraudulent, the analysis notes comprising a plurality of characteristics relating to properties or services being offered as part of the historical travel-related transactions, entities offering the properties or services as part of the historical travel-related transactions, entities accepting the offers of the properties or services as part of the historical travel-related transactions, and/or financial information relating to the historical travel-related transactions.
